(19) United States
(12) Patent Application Publication
(10) Pub. No.: US 2017/0161646 A1
(43) Pub. Date: Jun. 8, 2017

(54) RELOCATION OF USERS BASED ON USER PREFERENCES

(71) Applicant: International Business Machines Corporation, Armonk, NY (US)

(72) Inventors: Tamer E. Abuelsaad, Somers, NY (US); Edward T. Geraghty, JR., Cambridge, MA (US); Tolga Oral, West Roxbury, MA (US)

(21) Appl. No.: 14/957,862

(22) Filed: Dec. 3, 2015

(51) Int. Cl. G06Q 10/02; G06Q 10/06; G06F 17/30

(52) U.S. Cl. CPC G06Q 10/02; G06F 17/30241; G06Q 10/06312

(57) ABSTRACT

Computer implemented methods and systems to recommend a relocation of a user based on user preferences including receiving, by a processor, user information including at least one user-define threshold related to one or more environmental characteristics and a user's location, receiving environmental data from one or more sensors related to the user's location, the environmental data related to the one or more environmental characteristics, determining the environmental data exceeds the at least one user-defined threshold, and generating a relocation recommendation to indicate a recommended location different from the user's location.

### BACKGROUND

The present disclosure relates generally to management of personnel and, more specifically, to relocation of users or personnel based on user preferences.

More and more businesses are adopting an open workspace approach. In such configurations, multiple people may be located within a single common area or space. Similarly, such open space configurations exist in education institutions, libraries, restaurants, etc. Within these spaces, a free flow of information and exchanges between the occupants of the space may exist.

While this model is beneficial in many ways, it may present a challenge with respect to certain individuals' preferences with respect to environmental conditions such as noise levels, lighting levels, and/or air quality. For example, some users or personnel working in an open workspace area may work more efficiently with lower noise levels present such that they may not be distracted. However, not every person is aware of how loud their voice is, or in certain instances, a group discussion or other collaboration may be potentially disruptive to other persons in the same area. For example, when groups of people are working together, the noise generated by the group may be amplified.

In such instances, an individual may be required to try to find a more appropriate location in which to work or conduct other business. Finding an adequate or suitable location may be difficult to find.

### SUMMARY

According to embodiments, a method, system, and computer program product are provided for recommending a relocation of a user based on user preferences including receiving, by a processor, user information including at least one user-defined threshold related to one or more environmental characteristics and a user's location, receiving environmental data from one or more sensors related to the user's location, the environmental data related to the one or more environmental characteristics, determining the environmental data exceeds the at least one user-defined threshold, and generating a relocation recommendation to indicate a recommended location different from the user's location.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a system for enabling management of personnel and relocation of users employing an embodiment of the present disclosure;

FIG. 2 depicts a schematic illustration of a closed environment configured with a relocation recommendation system in accordance with an embodiment of the present disclosure; and

FIG. 3 is a flow process for providing relocation recommendations to a user of a system in accordance with an embodiment of the present disclosure.

### DETAILED DESCRIPTION

Various embodiments described herein provide systems and processes for providing recommendations and/or suggestions for relocating users of the system based on preferences of the user. Further, various embodiments of the present disclosure are directed to relocating a user based on noise level preferences in a space. Further, embodiments provided herein may provide recommendations to a user when they arrive at a location for where the user may be most comfortable, based on their preferences.

More and more businesses are adopting an open workspace approach. While this model is beneficial in many ways, it may present a challenge from a noise level perspective. For example, some users or personnel working in an open workspace area may work more efficiently with lower noise levels present such that they may not be distracted. However, not every person is aware of how loud their voice is, or in certain instances, a group discussion or other collaboration may be potentially disruptive to other persons in the same area. For example, when groups of people are working together, the noise generated by the group may be amplified. Various embodiments provided herein are configured to mitigate this, by alerting the people making noise and/or offering relocation options for other people in the same space.

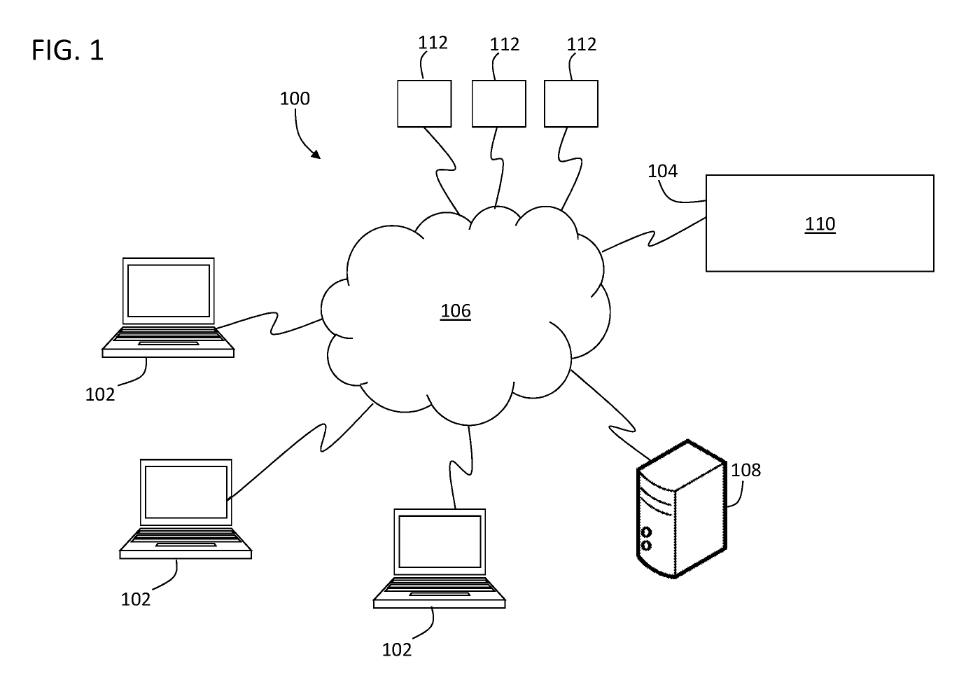

Referring to FIG. 1, a block diagram of a system 100 for enabling a relocation recommendation system pertaining to a discussion in accordance with an embodiment is shown. The system 100 includes an application, hereinafter relocation recommendation system 110, for performing the processing described herein that is executed by one or more computer programs located on a host system 104 and/or a user system(s) 102. The relocation recommendation system 110 may include an asset management application to perform tracking of users, monitoring environmental characteristics in a space (e.g., noise levels, air quality, lighting, etc.).

The system 100 depicted in FIG. 1 includes one or more user systems 102 through which users, e.g., personnel located in a closed environment, at one or more locations within the closed environment may communicate to and/or receive communication from the host system 104. As used herein, a closed environment may be any space wherein multiple people may congregate, including but not limited to shared or open workspaces, libraries, restaurants, conference rooms, etc. The user systems 102 are coupled to the host system 104 via a network 106. Each user system 102 may be implemented using a general-purpose computer executing a computer program for carrying out the processes described herein. The user systems 102 may be user devices such as personal computers (e.g., a laptop, a tablet computer, a cellular telephone, etc.) or host attached terminals. In some embodiments, the processing described herein may be shared by one or more user systems 102 and the host system 104. The user systems 102 may also include game consoles, network management devices, and field programmable gate arrays. In addition, multiple user systems 102 and/or host systems 104 may be concurrently operating to provide recommendations to users within the closed environment.

The network 106 may be any type of known network including, but not limited to, a wide area network (WAN), a local area network (LAN), a global network (e.g. Internet), a virtual private network (VPN), a cloud network, and an intranet. The network 106 may be implemented using a wireless network or any kind of physical network implementation known in the art. A user system 102 may be coupled to the host system 104 through multiple networks 106 (e.g., cellular and Internet) so that not all user systems 102 are coupled to the host system 104 through the same network 106. One or more of the user systems 102 and the host system 104 may be connected to the network 106 in a wireless fashion. In one non-limiting embodiment, the network is the Internet and one or more user systems 102 execute a user interface application (e.g. a web browser) to contact the host system 104 through the network 106. In another non-limiting example embodiment, the user system 102 is connected directly (i.e., not through the network 106) to the host system 104.

Further, one or more sensors 112 may be configured in communication with the host system 104 in a similar fashion as the user systems 102 are connected to the host system 104. In a further non-limiting embodiment, the host system 104 is connected directly to or contains a storage device 108. The network 106 may be employed by the relocation recommendation system 110 such that the relocation recommendation system 110 may communicate with one or more resources, either directly or indirectly, including but not limited to the user systems 102 and/or the one or more sensors 112, as described herein.

The storage device 108 includes data relating to the relocation recommendation system 110 and/or data relating to one or more resources, such as user preferences and/or profiles as described herein. In some embodiments, the storage device 108 may be implemented using a variety of devices for storing electronic information. In an example embodiment, data stored in the storage device 108 includes, but is not limited to, one or more user profiles, one or more noise level criteria, thresholds, and other data utilized by embodiments described herein. It is understood that the storage device 108 may be implemented using memory contained in the host system 104 or that it may be a separate physical device. The storage device 108 may be logically addressable as a consolidated data source across a distributed environment that includes the network 106. Information stored in the storage device 108 may be retrieved and manipulated via the host system 104 and/or via a user system 102.

The host system 104 depicted in FIG. 1, in some embodiments, may be implemented using one or more servers operating in response to a computer program stored in a storage medium accessible by the server. The host system 104 may operate as a network server (e.g., a web server) to communicate with the user systems 102. The host system 104 handles sending and receiving information to and from the user systems 102 and can perform associated tasks. The host system 104 may also include a firewall to prevent unauthorized access to the host system 104 and enforce any limitations on authorized access, e.g., permitting only designated users and/or other authorized persons to access the relocation recommendation system 110. For instance, an administrator may have access to the entire system and have authority to modify portions of the system and/or permissions thereto. A firewall may be implemented using conventional hardware and/or software, as is known in the art.

The host system 104 may also operate as an application server. The host system 104, in such embodiments, may execute one or more computer programs, including the relocation recommendation system 110, to provide aspects of embodiments as described herein. Processing may be shared by the user systems 102 and the host system 104 by providing an application to the user systems 102. Alternatively, the user systems 102 can include stand-alone software applications for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

As shown, the one or more sensors 112 may be in communication with the host system 104 and the relocation recommendation system stored thereon. The sensors 112 may be located or distributed throughout a closed environment. The sensors 112 may be configured to monitor and/or collect information regarding various environmental characteristics, such as noise levels, air quality, light levels, etc. For example, the sensors 112 may be microphones, light sensors, air quality sensors, or other types of sensors that may collect data about ambient and/or environmental conditions within a space or area. In some embodiments, the sensors 112 may be integrated into and/or part of the user systems 102. For example, when the user system 102 is a smart phone or other device, a microphone and/or light sensor of the smart phone may be used to collect environmental data and information and transmit it to the host system 104. In some such embodiments, the smart phone, or other similar device, may have an app or application running thereon that is configured to collect and transmit information to the host system 104.

During a relocation recommendation action, one or more users may use a user system 102 to communicate through the network 106 and provide user profiles and/or preferences to the relocation recommendation system 110. The relocation recommendation system 110 may also receive information or data from the one or more sensors 112, herein after environmental data. The relocation recommendation system 110 may then compare the collected environmental data with the user profiles or preferences to determine specific locations to recommend to the users such that they may be relocated to places within a closed environment that meet their preferences. The user profile may include tolerances and/or thresholds that the user may define related to one or more environmental or ambient conditions and/or characteristics. The user profile may be generated by input by the user and/or learned by the system as the system tracks the user's habits and activity and comparing it to environmental data collected by the system.

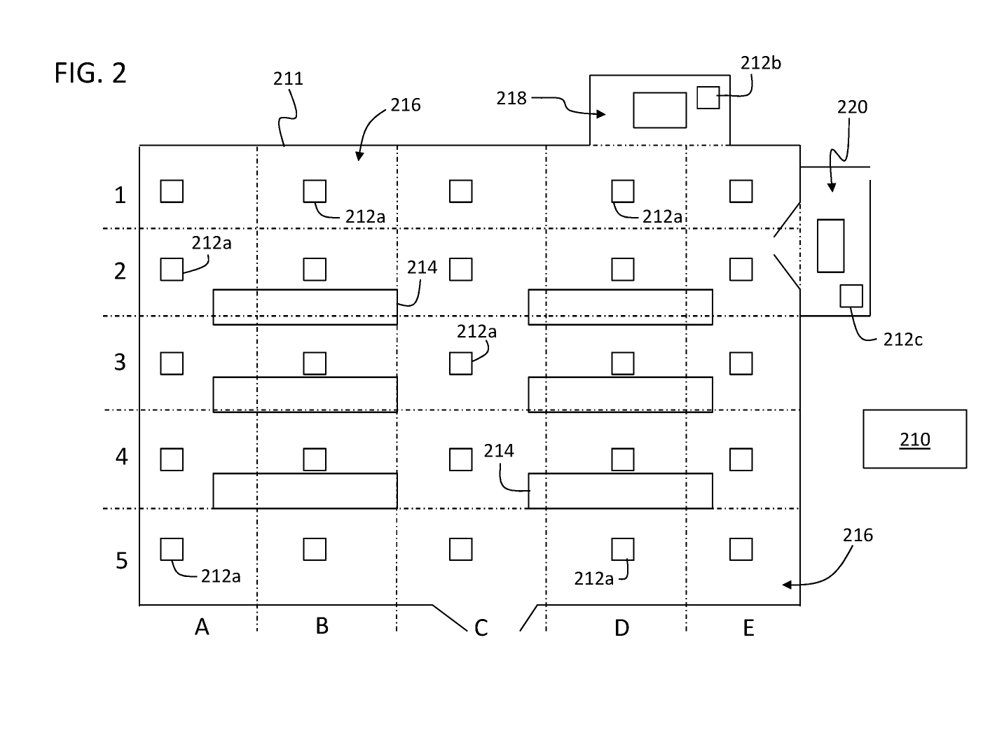

Turning now to FIG. 2, a schematic illustration of a closed environment 211 that may employ one or more embodiments described herein. As shown, the closed environment 211 may include one or more tables 214 which may be configured for use by one or more users within the closed environment 211. The closed environment 211 may be an open workspace, a library, or other room that multiple people may occupy.

A plurality of sensors 212 (as shown sensors 212a, 212b, and 212c) may be distributed and installed throughout the closed environment 211. The sensors 212 may be positioned to divide the closed environment 211 into a plurality of subspaces 216, 218, 220, wherein one sensor 212 (or one group of sensors) is configured to detect, monitor, and/or collect environmental data from an associated subspace 216, 218, 220. A plurality of first subspaces 216 may be defined within a portion of the closed environment 211, with the first subspaces 216 collectively defining a common space of the closed environment. A second subspace 218 may be a space that is separated from the common space defined by the first subspaces 216, such as an alcove, a side room, etc. Further, a third subspace 220 may be a space that is separated from the common space defined by the first subspaces 216, such as a closed room, a quiet room, etc. As shown, the second subspace 218 does not include doors and the third subspace 220 includes doors that may enable physically dividing the third subspace 220 from the common space defined by the first subspaces 216.

As shown, the common space defined by the first subspaces 216 of the closed environment 211 may be divided into a grid-like pattern such that each subspace 216 may be characterized by a position or data point, such as A-1, A-2, B-1, C-5, etc. Further, as shown, each first subspace 216 includes an associated first sensor 212a. Similarly, the second subspace 218 includes an associated second sensor 212b, and the third subspace 220 includes an associated third sensor 212c. As will be appreciated by those of skill in the art, the closed environment 211 may be divided and/or separated into any combination of subspaces and may include one or more separate or divided subspaces.

A relocation recommendation system 210 may be configured to receive data from the plurality of sensors 212 that are distributed throughout the closed environment 211. The relocation recommendation system 210 may also have information related to each subspace 216, 218, and 220; such that the relocation recommendation system 210 can correlate environmental data obtained from a sensor 212 with a particular subspace 216, 218, 220.

Users, such as personnel or other persons located within the closed environment 211, may each have user profile associated therewith. Each user profile may include one or more user preferences regarding a particular user's preferences related to ambient or environmental characteristics, i.e., the environmental data. For example, the user's preferences may relate to ambient noise levels that they prefer to work in, air quality aspects, and/or lighting preferences. The user profile is generated from user information that may be input by a user or learned by the relocation recommendation system 210. As such, the user information may include a user's preferences related to environmental characteristics, such that various user-defined thresholds related to environmental characteristics are generated. The user-defined thresholds within the user information or user profile may be values or levels that, if exceeded, may be uncomfortable or not preferred by a user, e.g. a user cannot concentrate or work if certain threshold values are exceeded. For example, user-defined the threshold may be a volume level, a light level, or an air quality level that if exceeded would be uncomfortable for the user.

When a user is located in a particular subspace, the relocation recommendation system 210 may track and monitor the user's location, based on a detection of the user by an associated sensor 212 in the subspace 216, 218, 220 that the user is located in. The relocation recommendation system 210 may also obtain or have access to the user's profile including the user-defined threshold(s). Thus, the relocation recommendation system 210 may include information related to the particular user (e.g., environmental characteristic preferences) and the subspace where the user is located. From this, the relocation recommendation system 210 may determine if the environmental data (i.e., the levels of the environmental characteristics) of the particular subspace is at levels that exceed a user-defined threshold and thus would be uncomfortable or unpleasant for the user.

The relocation recommendation system 210 may perform a check, and if the environmental data exceed a user-defined threshold, defined in a user profile, the relocation recommendation system 210 may provide a recommendation to the user to move to a different subspace within the closed environment 211, or may make a recommendation for the user to leave the closed environment 211. For example, the relocation recommendation system 210 may have information, including environmental data, regarding other closed environments within a building that contains the closed environment 211.

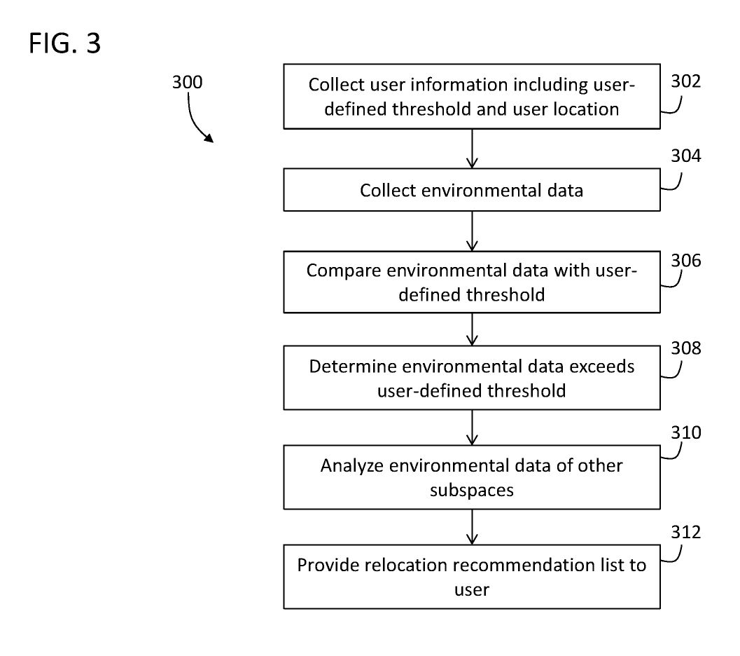

Turning now to FIG. 3, a flow process 300 of a relocation recommendation system in accordance with an embodiment of the present disclosure is shown. The flow process 300 may be performed within or by a system as shown and described above. For example, the flow process 300 may be performed by a host system that contains relocation recommendation system. The relocation recommendation system may be configured to receive information from one or more sensors within a closed environment and further may receive information regarding users within the closed environment.

At block 302, the system may collect user information, including a user's location and a user's profile containing one or more user-defined thresholds related to one or more environmental characteristics. In some embodiments, the system may retrieve the user information directly from a user system or device, such as a smartphone, computer, electronic card or badge, RFID, or the like. Further, in some embodiments, user profiles may be stored within a memory or other storage device of the relocation recommendation system. In some embodiments, the user information, particularly the user's location, may be obtained via GPS, Bluetooth®, Wi-Fi, Li-Fi, or other method or mechanism for determining a location of the user. In some embodiments, a user device that is with the user may connect to or be detected by the user such that the connection itself determines and indicates the user's location.

At block 304, the system may collect environmental data. The environmental data may be collected and/or detected by one or more sensors located within the closed environment. In a non-limiting example, the system may communicate with one or more sensors located in the same area or subspace where the user is located. Alternatively or in combination therewith, the system may collect environmental data from one or more user systems, as described above. Further, as noted above, the environmental data may include noise levels, lighting levels, air quality levels, etc., i.e., measurements of the environmental characteristics defined in the user profile.

At block 306, the system may compare the collected environmental data with the one or more user-defined thresholds contained in a user profile. For example, the system may compare the environmental data with one or more criteria, tolerances, values, and/or thresholds that the user has defined related to environmental conditions and/or characteristics. As such, the system may make a comparison between the obtained/collected environmental data and the user-defined thresholds of the user.

At block 308, the system may determine that the environmental data, and thus the environmental characteristics within the subspace where the user is located exceed one or more user-defined thresholds. For example, it may be determined that a particular environmental data (e.g., noise level, light level, air quality level, etc.) is outside a range or above a threshold or level contained in the user profile. That is, a measured or detected data point associated with the environmental characteristics exceeds a user-defined level that is unacceptable, uncomfortable, or unpleasant.

At block 310, the system may analyze environmental data for one or more other subspaces within or around the closed environment. The analysis performed by the system may include a determination of one or more other subspaces that have environmental characteristics that satisfy or are within the user's preferences defined in the user profile, i.e., levels below the user-defined thresholds. The system may then generate a relocation recommendation list containing all the subspaces that satisfy the user's preferences. The relocation recommendation list may include one or more subspaces that are different from the user's current location and have environmental characteristics that are within the user's profile as acceptable, i.e., below one or more user-defined thresholds.

The system may prioritize the relocation recommendation list such that the subspaces listed in the relocation recommendation list are ordered in view of various user specific criteria. For example, the system may order or prioritize the relocation recommendation list such that the closest subspaces, or ones is near proximity, that satisfy the user's preferences are listed first. Alternatively, the relocation recommendation list may be ordered or prioritized based on the environmental characteristics of the other subspaces, such that the list may provide the subspace that best fits with the user preferences defined in the user profile. For example, if the user has preferences related to noise, lighting, and air quality, the system may list subspaces that satisfy all three criteria first, and then list subspaces that satisfy only two, and so on. The relocation recommendation list may provide information to the user indicating which preferences or criteria are satisfied.

At block 312, the system may provide the user with the relocation recommendation list. For example, the system may send a notification to the user with a list of subspaces that are within the user's preferences and recommend the user to move to one of the subspaces on the relocation recommendation list. The notification may be made by text message, e-mail, or other message. In some embodiments, the notification may be transmitted to another person or system which may then be prompted to notify the user to move to a different location. For example, the message may be transmitted to a concierge, who can then approach the user and suggest the user to move to a more satisfactory location.

As will be appreciated by those of skill in the art, if the system determines that a user's preferences are satisfied, the system may take no further action.

The system may further include other features. For example, in addition to providing a user with a relocation recommendation, the system may further be configured to provide a notification within the subspace that a user within the subspace has preferences that are not being met. For example, each subspace may be equipped with one or more indicators, such as lights or speakers that may announce that the environmental conditions (e.g., noise levels) are not acceptable or exceed a user-defined threshold. Such a configuration may be used to alert people or other users in the subspace so that they can take actions to meet the user's preferences. For example, a light may turn on that indicates that noise levels are too high for a user in the subspace and any users in the space should lower their volume, e.g., turn down speaker volume on a phone or computer, talk more quietly, etc.

Further, in some embodiments, the system may track multiple people in a group and make a recommendation to the group to move to a more appropriate location. For example, with reference to the schematic illustration in FIG. 2, if a group of people are located within the common space defined by first subspaces 216, the system may send a notification to one or more of the users of the group that they should move to a more appropriate subspace, such as the second subspace 218 or the third subspace 220. That is, for example, in some embodiments, the system may be configured to recommend a group of people to move from a common space to a private conference room. As will be appreciated by those of skill in the art, the system may further make recommendations to a loud individual to move to a more appropriate location, and this is not limited only to groups of people.

Furthermore, in some embodiments, the system may be configured to alter or augment the environmental conditions and characteristics. For example, the system may include one or more speakers and the system may, as appropriate based on user preferences, increase a white or pink noise. Such action may be taken to mask other ambient noise in the area. Similarly, the system may be connected to an air quality system of the closed environment, and the system may increase or decrease a temperature in the subspace of the closed environment and/or may increase or decrease airflow within the subspace. Further, the system may be connected with lighting features of the subspaces such that electrical lighting may be adjusted and/or shades may be controlled to adjust ambient external lighting in a particular subspace.

Further, in some embodiments, the system may be configured to provide a reservation function. For example, the system may be configured to detect when a user enters a building containing the system and may collect or retrieve a user profile, or the user profile may be stored within the system. Based on the user profile, and when the user enters the building, the system may be configured to reserve a room or subspace for the particular user that fits within the user's profile. In such configurations, the system may be configured to obtain reservation information regarding subspaces of the building, and may further be configured to automatically input reservation information for the particular user.

Further, the system may be configured to receive input from a user externally. For example, a user may send a request to the system prior to arriving at the building that they will need a subspace having particular environmental conditions. The system may then analyze the subspaces that are part of the system, make a determination of the most appropriate subspace, and reserve the selected subspace. In any of the above configurations, the system may be integrated with a digital calendar system such that invites or other reservations may be incorporated into the digital calendar system.

As described above, the user profile may be learned or input by a user. However, in some instances a user may not have a profile, such as a visitor to a location employing systems described herein. In such instances, a guest profile may be generated for the visitor or guest. The guest profile may be set with a predetermined nominal or default level. Alternatively, the visitor may indicate to a person in charge of the system, e.g., an operator, that they are visiting for a particular purpose and/or have specific environmental condition requirements. In such instances, the operator may load a predefined profile that matches the needs of the visitor or the operator may modify or generate a guest profile that is in accord with the visitor's preferences.

Technical effects and benefits include a relocation recommendation system configured to receive as input a user profile and environmental data related to subspaces of a closed environment and make relocation recommendations to a user based on the inputs. Further technical effects include actively learning a user's preferences by tracking a particular user and comparing the user's actions and habits with collected environmental data. Thus, advantageously, systems and processes described herein may automatically generate, and dynamically adjust, a user's profile such that the user's preferences are learned and appropriate relocation recommendations may be made by the system to the user.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A computer implemented method to recommend a relocation of a user based on user preferences, the method comprising:
receiving, by a processor, user information including at least one user-defined threshold related to one or more environmental characteristics and a user's location;
receiving environmental data from one or more sensors related to the user's location, the environmental data related to the one or more environmental characteristics;
determining the environmental data exceeds the at least one user-defined threshold; and
generating a relocation recommendation to indicate a recommended location different from the user's location.

2. The computer implemented method of claim 1, further comprising, receiving environmental data from one or more sensors from one or more locations that are different from the user's location, wherein the recommended location is at least one location selected from the one or more locations that are different from the user's location and wherein each location of the one or more locations has environmental characteristics below the at least one user-define threshold.

3. The computer implemented method of claim 1, further comprising reserving, in a reservation system, a location based on the at least one user-defined threshold.

4. The computer implemented method of claim 1, further comprising sending the relocation recommendation to one or more other person in the user's location so that the one or more other person may be relocated to the recommended location.

5. The computer implemented method of claim 1, further comprising at least one of indicating in the user's location that the one or more environmental characteristics in the user's location exceed the at least one user-defined threshold or altering at least one environmental characteristic in the user's location.

6. The computer implemented method of claim 1, further comprising tracking a user and environmental data to generate a user profile including the user preferences.

7. The computer implemented method of claim 1, wherein the environmental data comprises data related to at least one of noise, air quality, or lighting, and the at least one user-defined threshold is a user-defined value associated with the at least one of noise, air quality, or lighting.

8. A system to recommend a relocation of a user based on user preferences comprising:
a memory having computer readable instructions; and
a processor configured to execute the computer readable instructions, the computer readable instructions comprising:
receiving, by the processor, user information including at least one user-defined threshold related to one or more environmental characteristics and a user's location;
receiving environmental data from one or more sensors related to the user's location, the environmental data related to the one or more environmental characteristics;
determining the environmental data exceeds the at least one user-defined threshold; and
generating a relocation recommendation to indicate a recommended location different from the user's location.

9. The system of claim 8, further comprising, receiving environmental data from one or more sensors from one or more locations that are different from the user's location, wherein the recommended location is at least one location selected from the one or more locations that are different from the user's location and wherein each location of the one or more locations has environmental characteristics below the at least one user-define threshold.

10. The system of claim 8, further comprising, reserving, in a reservation system, a location based on the at least one user-defined threshold.

11. The system of claim 8, further comprising sending the relocation recommendation to one or more other person in the user's location so that the one or more other person may be relocated to the recommended location.

12. The system of claim 8, further comprising at least one of indicating in the user's location that the one or more environmental characteristics in the user's location exceed the at least one user-defined threshold or altering at least one environmental characteristic in the user's location.

13. The system of claim 8, further comprising tracking a user and environmental data to generate a user profile including the user preferences.

14. The system of claim 8, wherein the environmental data comprises data related to at least one of noise, air quality, or lighting, and the at least one user-defined threshold is a user-defined value associated with the at least one of noise, air quality, or lighting.

15. A computer program product to a relocation of a user based on user preferences, the computer program product comprising a computer readable storage medium having program instructions embodied therewith, the program instructions executable by a processor to cause the processor to:
receive, by the processor, user information including at least one user-defined threshold related to one or more environmental characteristics and a user's location;
receive environmental data from one or more sensors related to the user's location, the environmental data related to the one or more environmental characteristics;
determine the environmental data exceeds the at least one user-defined threshold; and
generate a relocation recommendation to indicate a recommended location different from the user's location.

16. The computer program product of claim 15, further comprising, causing the processor to receive environmental data from one or more sensors from one or more locations that are different from the user's location, wherein the recommended location is at least one location selected from the one or more locations that are different from the user's location and wherein each location of the one or more locations has environmental characteristics below the at least one user-define threshold.

17. The computer program product of claim 15, further comprising causing the processor to reserve, in a reservation system, a location based on the at least one user-defined threshold.

18. The computer program product of claim 15, further comprising, causing the processor to send the relocation recommendation to one or more other person in the user's location so that the one or more other person may be relocated to the recommended location.

19. The computer program product of claim 15, further comprising causing the processor to at least one of indicate in the user's location that the one or more environmental characteristics in the user's location exceed the at least one user-defined threshold or alter at least one environmental characteristic in the user's location.

20. The computer program product of claim 15, wherein the environmental data comprises data related to at least one of noise, air quality, or lighting, and the at least one user-defined threshold is a user-defined value associated with the at least one of noise, air quality, or lighting.
